(19) United States
(12) Patent Application Publication
(10) Pub. No.: US 2002/0141512 A1
(43) Pub. Date: Oct. 3, 2002

(54) Process and base station for baseband processing of received signals

(75) Inventor: Gero Blanke, Murr (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/079,881

(22) Filed: Feb. 22, 2002

(30) Foreign Application Priority Data
Mar. 29, 2001 (DE) 101 15 610.3

(51) Int. Cl. H04L 27/06

(52) U.S. Cl. 375/316

(57) ABSTRACT

The invention concerns a process for baseband processing of received signals (2) in at least one baseband unit (4) of a base station (Node B) of a radio telecommunications system (1), wherein the baseband unit (4) or every baseband unit (4) has at least one computing element (8), in particular a microprocessor. In order to realize baseband processing in the base station (Node B), in which, on the one hand, hardware can be eliminated and, on the other hand, an adequate computing capacity is available so that, even for received signals (2) of poor quality, processing can be ensured within a specified time period and with a specified quality, it is proposed that the baseband processing is assigned to at least one specific computing element (8) of at least one baseband unit (4) according to the utilization of the computing elements (8) of the baseband units (4).

### BACKGROUND OF THE INVENTION

The present invention concerns a process for baseband processing of received signals in at least one baseband unit of a base station of a radio telecommunications system. The baseband unit or every baseband unit has at least one computing element, in particular a microprocessor.

The invention is based on a priority application DE 101 15 610.3 which is hereby incorporated by reference.

The invention also concerns a base station of a radio telecommunications system, containing at least one high-frequency (HF) unit for processing analogue signals and several baseband units for processing digital signals. Each of the baseband units has at least one computing element, in particular a microprocessor.

Finally, the present invention concerns a radio telecommunications system containing a number of mobile radio units, several base stations that are in radio contact with the mobile radio units, and at least one control device for controlling the radio telecommunications system, which is linked to the base stations.

### SUMMARY OF THE INVENTION

A radio telecommunications system with base stations of the type stated at the outset is, for example, known from the prior art as a so-called universal mobile telecommunications system (UMTS). In UMTS telecommunications systems, the base stations are described as Node B and the control devices as radio network controllers (RNC). In a so-called uplink mode, data are transmitted from the mobile radio units to the base station via a radio link. The data from various radio units are modulated according to the so-called code division multiple access (CDMA) process and transmitted via a common channel. Several channels are combined into one radio signal, which is received as a received signal in those base stations with which the radio units are in radio contact. The received signals are processed in the base stations.

The processing of the received signals in the base stations is carried out separately for analogue and for digital signals. While the analogue signals are processed in so-called high-frequency (HF) units, the digital signals are processed in so-called baseband units. In the case of signals modulated according to the CDMA process, the digital processing in the baseband units contains, among other things, so-called symbol rate processing and so-called chip rate processing. Chip rate processing is employed to recover the individual channels from the received signal. Symbol rate processing is employed on an individual channel in order to recover the transmitted data of the individual radio units from the signal transmitted via the channel.

The base stations receive signals via different channels. According to the prior art, for the processing of the analogue and digital signals, a specified reference is provided in a base station between a channel and the HF units or the baseband units, respectively, which process the signals of this channel. However, this specified reference requires a substantially constant effort for the baseband processing. In modern radio telecommunications systems in particular, such as for example UMTS telecommunications systems, the baseband processing effort, in particular for chip rate processing, as used in a so-called rake receiver, for example, is not constant, but depends on the quality of the received signal, that is to say on the number of fingers of a rake receiver, that are required for the reception of a signal of a specific quality. The computing capacity required for the baseband processing for the received signals of a channel can therefore vary very widely. In order to always have sufficient computing capacity, it is necessary to design this to be relatively large to be able to ensure processing of the received signal within a specified time and with a specified quality, even in the worst case. On average, however, large parts of this available computing capacity are not needed since the quality of the received signal is usually better than the worst case.

The object of the present invention is therefore to realise, in base stations of radio telecommunications systems, baseband processing in which, on the one hand, hardware can be eliminated in the base station and, on the other hand, an adequate computing capacity is available so that, even for received signals of poor quality, processing can be ensured within a specified time period and with a specified quality.

To achieve this object, based on the process of the type stated at the outset, it is proposed that the baseband processing is assigned to at least one specific computing element of at least one baseband unit according to the utilisation of the computing elements of the baseband units.

According to the invention, it is therefore proposed to first determine the utilisation of the individual computing elements of the baseband units. Depending on the utilisation of the computing elements, the baseband processing of a received signal waiting to be processed is then assigned to at least one specific computing element of at least one baseband unit. According to the present invention, it is possible to assign the entire baseband processing to one computing element of a baseband unit that has the required available computing capacity. However, it is also conceivable to share the baseband processing with several computing elements of one or more baseband units which, as a whole, can then make available the required computing capacity. The crux of the present invention is therefore to replace the rigid assignment between HF units and baseband units known from the prior art, by a utilisation-related adaptive assignment.

The more hardware that can be eliminated in a base station, then the more uniformly the baseband processing can be distributed among all computing elements of all baseband units. Within the channels which distribute the computing capacity of the computing elements of the baseband units of a baseband computer card (baseband board) for the baseband processing of a carrier, a certain equalisation between the channels within the baseband board can be assumed because of a statistical distribution of the quality of the received signals. Nevertheless it is possible that a baseband board that was originally designed for a specific carrier, can provide different baseband board computing capacity or itself requires additional computing capacity from other baseband boards.

According to a possible embodiment, a switching matrix is arranged on the one hand between the analogue processing sections of the base station (HF units) and the digital baseband processing units (baseband units) on the other hand. The switching matrix must be able to process the relatively high data rates which occur between a transmitter/receiver device (transceiver) of an HF unit and a baseband unit that has spare computing capacity. For this the switching matrix has optical transmission means, for example.

However, to avoid switching the high data rates in the switching matrix, according to an advantageous development of the present invention it is proposed that the baseband processing be assigned to at least one specific computing element of at least one specific baseband unit, and that the baseband processing within the baseband unit be assigned, at least partially, to at least one further computing element of the baseband unit. According to this development, the baseband processing is thus assigned to several computing elements of the same baseband unit. The equalisation of the computing capacities therefore takes place between the computing elements of the same baseband unit.

According to another advantageous development of the present invention, it is proposed that the baseband processing be assigned to at least one specific computing element of at least one baseband unit, and that the baseband processing be assigned, at least partially, to a further computing element of at least one further baseband unit. According to this development, the computing capacity is therefore equalised between the computing elements of several baseband units of the same or different baseband boards.

According to a preferred embodiment of the present invention, it is proposed that the received signals be transmitted via several channels, one channel being assigned to each computing element, and that the baseband processing of a channel be assigned, at least partially, to a further computing element if the available computing capacity of the at least one computing element assigned to the channel is inadequate. If a received signal with a relatively poor quality is transmitted via a specific channel and the available computing capacity of the computing element assigned to this channel is inadequate in order to process the received signal within a specified computing time and with a specified quality, at least one further computing element is employed for the baseband processing of the received signal transmitted via this channel. As a first option, the further computing element can participate in the baseband processing in addition to the original computing element or, as a second option, the further computing element can even take over the complete baseband processing from the original computing element. The second option is then conceivable, for example, if the full computing capacity of the further computing element is available, while the original computing element is partially occupied with the baseband processing of other channels of the received signal.

Advantageously, the expected available computing capacity of the at least one computing element assigned to the channel is estimated prior to the start of the baseband processing. Before the actual baseband processing is started, the expected available computing capacity can be determined by means of the total computing capacity of the at least one computing element and an expected utilisation. The expected utilisation of the at least one computing element can be estimated by means of the contents of the data of the received signal and by means of commands of a watchdog unit of the base station prior to the start of the baseband processing. If the expected available computing capacity of the at least one computing element is below a specified threshold value, to relieve the load, at least one further computing element is employed for the baseband processing or the entire baseband processing is switched to the at least one further computing element.

Alternatively or additionally, it is proposed to monitor the utilisation of the at least one computing element assigned to the channel during the baseband processing. If it is shown that during the baseband processing the available computing capacity of the at least one computing element assigned to the channel falls below a specified threshold value, at least one further computing element is employed for the baseband processing, or the entire baseband processing is switched to the at least one further computing element.

As a further solution to the problem of the present invention, based on the base station of the type stated at the outset, it is proposed that the base station has first means for determining the utilisation of the computing elements of the baseband units and second means for assigning received signals waiting for baseband processing to at least one computing element of at least one baseband unit, the assignment being implemented according to the utilisation of the computing elements.

According to an advantageous development of the present invention it is proposed that the computing elements of the baseband units be interconnected via high-speed interfaces. The high-speed interfaces are constructed, for example, as so-called link ports which are designed for the connection of peripheral devices or other computing elements of the same type. The received signals waiting for baseband processing can be distributed among different computing elements via the connections between the individual computing elements. For example, the distribution of the received signals among the different computing elements can be co-ordinated by a watchdog unit, a co-processor or a direct memory access (DMA) machine, for example. In order to distribute the received signals waiting for processing to the different computing elements, the data of the received signals are stored in the memory cells of the corresponding computing elements. The data are then retrieved from the computing elements for processing.

The embodiment with the connection of the computing elements via high-speed interfaces has the advantage over a switching matrix that said connection is substantially simpler and more economical to realise, since no complex, hardware-based fast switching of the high data rates is necessary between the HF units and the baseband units. By suitable preprocessing of the received signals in the computing elements of the baseband units, the data rates via the high-speed interfaces can be considerably reduced.

The second means for assigning the received signals to the at least one computing element are preferably constructed as a watchdog unit that passes the received signals waiting for baseband processing to a memory area of the at least one computing element.

Based on a radio telecommunications system of the type stated at the outset, as a further solution to the problem of the present invention, it is proposed that at least one of the base stations of the radio telecommunication system be constructed as a base station according to the invention.

### BRIEF DESCRIPTION OF THE DRAWINGS

Further features, possible applications of the invention are revealed in the following description of exemplary embodiments that are illustrated in the drawing. Here all described or illustrated features, either alone or in any combination, form the subject-matter of the invention, irrespective of their combination in the patent claims or their cross-reference, and irrespective of their wording or representation in the description or in the drawing, respectively. In the drawing:

FIG. 1 shows a radio telecommunications system according to the invention;

FIG. 2 shows a base station according to the invention; and

FIG. 3 shows a flowchart of a process according to the invention.

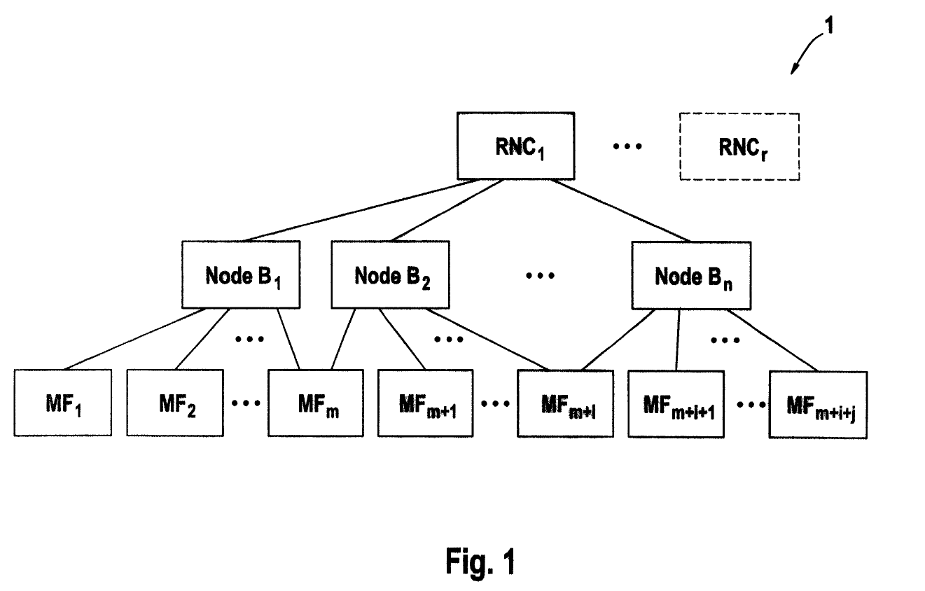

A radio telecommunications system, that is to say a universal mobile telecommunications system (UMTS) according to the invention, is shown in its entirety and denoted by the reference number 1 in FIG. 1. The radio telecommunications system 1 contains a number of mobile radio units MF, several base stations Node B, which are in radio contact with the mobile radio units MF, and at least one control device RNC (radio network controller), that is linked to the base stations Node B. In a so-called uplink mode, data from the mobile radio units MF are transmitted to the base stations Node B via the radio link. Data from various radio units MF are modulated according to the so-called code division multiple access (CDMA) method and transmitted via a common channel. Several channels are combined into one radio signal that is received as received signal 2 in those base stations Node B, with which the radio units MF are in radio contact. The received signals 2 are processed in the base stations Node B.

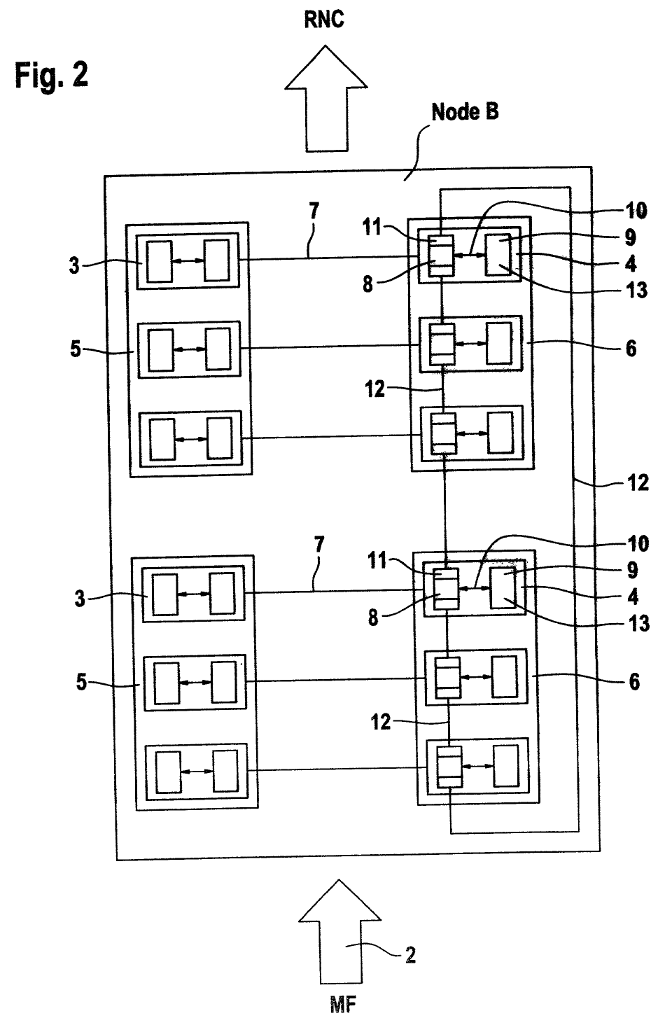

The processing of the received signals 2 (see FIG. 2) in the base stations Node B, is carried out separately for analogue and for digital signals. While the analogue signals are processed in so-called high-frequency (HF) units 3, the digital signals are processed in so-called baseband units 4. Several HF units 3 are combined in an HF board 5 and several baseband units 4 are combined in a baseband board 6. Each of the HF units 3 and the baseband units 4 has a computing element 8, in particular a microprocessor, and a memory device 9 in which data to be processed can be stored. The data are transferred via a transmission line 10 from the memory device 9 to the computing element 8 for processing.

For signals 2 modulated according to the CDMA method, the digital processing in the baseband units 4 includes, among others, so-called symbol rate processing and so-called chip rate processing. Chip rate processing is employed for recovery of the individual channels from the received signals 2. Symbol rate processing is employed on an individual channel to recover the transmitted data of the individual radio units MF from the signal transmitted via the channel. The base stations Node B receive signals via different channels. According to the prior art, for the processing of the analogue and digital signals, a specified reference is provided in a base station between a channel and the HF units 3 or the baseband units 4, respectively, which process the signals of this channel. This rigid relationship is clearly shown by the link circuits 7 between each HF unit 3 and the respective baseband unit 4. The crux of the present invention is to replace the rigid assignment between HF units 3 and baseband units 4 known from the prior art, by a utilisation-related adaptive assignment. The computing capacity of the base stations Node B can thus be adapted to the actual requirements, particularly in modern radio telecommunications systems, such as UMTS telecommunications systems 1, for example. The actual, required computing capacity to process a received signal 2 within a specified time period with a specified quality can in fact fluctuate widely, since it depends on the quality of the received signal 2. This particularly applies to chip rate processing as is used in a so-called rake receiver in the base stations Node B, for example. In a rake receiver, the computing effort, but also the quality of the signal, increases with the number of fingers.

In the base stations Node B according to the invention, the computing capacity of the baseband units 3 can therefore be reduced. For received signals 2 of conventional quality, the reduced computing capacity facilitates adequately fast and adequately good-quality processing. In the case of received signals 2 with a poorer quality, for which the provided computing capacity may not be adequate, the processing can be shared with several computing elements 8 of one or more baseband units 4 of one or more baseband boards 6, or assigned to one computing element 8 whose computing capacity is fully available.

The utilisation-dependent adaptive assignment of the received signals 2 to the computing elements 8 is facilitated so that the individual computing elements 8 of the baseband units 4 are interconnected via a high-speed interface 11. The high-speed interfaces 11 are constructed as so-called link ports which are designed for the connection of peripheral devices or other computing elements of the same type. The received signals 2 waiting for baseband processing can be distributed to different computing elements 8 of the baseband units 4 via the connections 12 between the individual computing elements 8. The distribution of the received signals 2 to the different computing elements 8 is co-ordinated by a watchdog unit, a co-processor or a direct memory access (DMA) machine, for example. In order to distribute the received signals 2 waiting for processing to the different computing elements 8, the data of the received signals 2 are stored in the memory cells 13 of the corresponding computing elements 8, and from there are retrieved from the computing elements for processing.

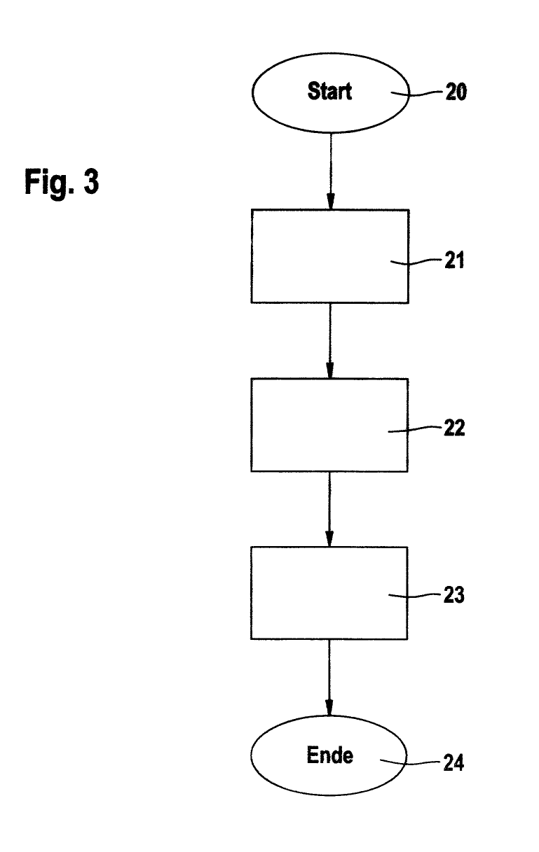

A flowchart of the process according to the invention is illustrated in FIG. 3. The process starts in a function block 20. The utilisation of the computing elements 8 of the baseband units 4 is then determined in a function block 21. This can be a current utilisation or a utilisation that is expected in the future. The data waiting for baseband processing are then distributed in a function block 22 to one or more computing elements 8 depending on the utilisation of the computing elements 8. However, in the case of distribution to several computing elements 8, this must definitely not involve the same baseband unit 4 or the same baseband board 6. The data are then processed in a function block 23 by the computing elements 8 within a specified time period and with a specified quality. The process is completed in a function block 24.

1. Process for baseband processing of received signals in at least one baseband unit of a base station of a radio telecommunications system, wherein the baseband unit or every baseband unit has at least one computing element, in particular a microprocessor, wherein the baseband processing is assigned to at least one specific computing element of at least one baseband unit according to the utilisation of the computing elements of the baseband units.

2. Process according to claim 1, wherein the baseband processing is assigned to at least one specific computing element of at least one specific baseband unit, and that the baseband processing within the baseband unit is assigned, at least partially, to at least one further computing element of the baseband unit.

3. Process according to claim 1, wherein the baseband processing is assigned to at least one specific computing element of at least one specific baseband unit, and that the baseband processing is assigned, at least partially, to at least one computing element of at least one further baseband unit.

4. Process according to one of claims 1 to 3, wherein the received signals are transmitted via several channels, wherein at least one channel is assigned to each computing element, and that the baseband processing of a channel is assigned, at least partially, to a further computing element, if the available computing capacity of the at least one computing element assigned to the channel is inadequate.

5. Process according to claim 4, wherein the expected utilisation of the at least one computing element assigned to the channel is estimated prior to the start of the baseband processing.

6. Process according to claim 4 or 5, wherein the utilisation of the at least one computing element assigned to the channel is monitored during the baseband processing.

7. Base station of a radio telecommunications system, containing at least one high-frequency unit for processing analogue signals and several baseband units for processing digital signals, wherein each of the baseband units has at least one computing element, in particular a microprocessor, said base station having first means for determining the utilisation of the computing elements of the baseband units and second means for assigning received signals waiting for baseband processing to at least one computing element of at least one baseband unit, wherein the assignment is implemented according to the utilisation of the computing elements.

8. Base station according to claim 7, said the computing elements of the baseband units being interconnected via high-speed interfaces.

9. Base station according to claim 7 or 8, said the second means being designed as a watchdog unit which pass the received signals waiting for baseband processing to a memory area of at least one computing element of at least one baseband unit.

10. Radio telecommunications system containing a number of mobile radio units, several base stations, that are in radio contact with the mobile radio units, and at least one control device for controlling the radio telecommunications system, which control device is linked to the base stations, said at least one of the base stations being designed according to one of claims 7 to 9.
